(19) United States
(12) Patent Application Publication
(10) Pub. No.: US 2024/0416738 A1
(43) Pub. Date: Dec. 19, 2024

(54) VEHICLE MOUNT

(71) Applicants: Hyundai Moror Company, Seoul (KR); Kia Corporation, Seoul (KR)

(72) Inventor: Seung Won KIM, Seoul (KR)

(73) Assignees: Hyundai Moror Company, Seoul (KR); Kia Corporation, Seoul (KR)

(21) Appl. No.: 18/533,926

(22) Filed: Dec. 8, 2023

(30) Foreign Application Priority Data
Jun. 16, 2023 (KR) 10-2023-0077150

(51) Int. Cl. B60K 5/12

(52) U.S. Cl. CPC B60K 5/1208

(57) ABSTRACT

A vehicle mount includes an internal pipe coupled to a vehicle-mounted device, an insulator molded to be integrated with an external diameter portion of the internal pipe, the insulator including a stacked structure formed therein and configured to allow a plurality of chambers to be vertically spaced from each other, a flow path plate formed to provide a flow path configured to allow fluid to be movable between the chambers in a state of being coupled to an external peripheral surface of the insulator and sealing the chambers including the stacked structure, and an external pipe coupled to and configured to surround the insulator and the flow path plate and coupled to a vehicle body side portion. It is an object of the present disclosure to provide the vehicle mount including an improved air damping mount structure configured for increasing a damping effect.

### CROSS-REFERENCE TO RELATED APPLICATION

The present application claims priority to Korean Patent Application No. 10-2023-0077150, filed on Jun. 16, 2023, the entire contents of which is incorporated herein for all purposes by this reference.

### BACKGROUND OF THE PRESENT DISCLOSURE

### Field of the Present Disclosure

The present disclosure relates to a vehicle mount. More particularly, it relates to a vehicle mount capable of mounting a vehicle-mounted device on a vehicle body in a vibration-insulated manner.

### Description of Related art

In general, when a powertrain apparatus including an engine and a transmission is mounted in an engine compartment of a vehicle having an internal combustion engine, mounting is performed using a mount to reduce vibration and noise transmitted from the powertrain apparatus to a vehicle body.

For example, when an engine is driven, an engine mount plays a role of insulating vibration generated by stroke of a piston and rotational torque of a crankshaft between a vehicle body and the engine mount.

In this regard, while a vehicle having an internal combustion engine has an engine mounted therein, an electric vehicle adopts a power electric (PE) system including a motor and a reducer. Accordingly, when the motor and the reducer are mounted on a vehicle body side portion in a PE room, mounting is performed using a dedicated mount for an electric vehicle capable of insulating gear whine noise, shock, jerk, vibration, and the like.

FIG. 1 is a perspective view showing a bush-type mount used in an electric vehicle, and shows a PE mount configured to mount a vehicle-mounted device such as a motor or a reducer forming a PE system.

The PE mount 1 includes an internal pipe (also referred to as an “inner core”) 2 coupled to a vehicle-mounted device such as a motor or a reducer forming a PE system, a rubber (also referred to as an “insulator”) 3 vulcanized and molded into a predetermined shape and provided on an external diameter portion of the internal pipe 2, and an external pipe 4 integrally coupled to the external surface of the rubber 3.

Among the components of the PE mount described above, the rubber 3 serves to insulate vibration transmitted through the internal pipe 2 from the motor and the reducer, preventing the vibration from being transmitted to the external pipe 4.

During mounting, the external pipe 4 of the PE mount 1 is press-fitted into a mounting hole of a bracket, which is a vehicle body side portion. The bracket may be a structure separately provided on the vehicle body side portion, such as a sub-frame having a motor and a reducer mounted thereon, or may be an integrally formed vehicle body side portion.

Furthermore, when the motor is mounted, a bolt is inserted to pass through the internal pipe 2 and the end of the bolt is screwed into a coupling hole of a motor housing in a state in which the coupling hole of the motor housing is aligned with a shaft insertion hole (an internal space of the internal pipe) 2a of the mount 1.

As a result, in a state in which the motor and the reducer of the electric vehicle are mounted on the vehicle body side portion such as the sub-frame 5 by the mount 1, the mount 1 insulates noise and vibration generated from the motor and reducer and prevents the noise and the vibration from being transmitted to the vehicle body side portion.

Meanwhile, since weight of a motor and a reducer forming a PE system of an electric vehicle is smaller than that of an engine (internal combustion engine), the electric vehicle generally utilizes a conventional rubber-type mount as a mount for the PE system (hereinafter referred to as a “PE mount”) instead of using a hydro-type mount.

The electric vehicle has the PE system including the motor and the reducer, the weight of which becomes smaller than that of a vehicle having an internal combustion engine, and the PE system may be simultaneously mounted on the front side and the rear side of the electric vehicle.

Accordingly, in the case of the front side of the electric vehicle, there is an advantage in that weight becomes lighter than that of the existing internal combustion engine vehicle. On the other hand, because the motor and the reducer are additionally provided on the rear side of the electric vehicle, the weight of the rear side becomes significantly heavier than that of the conventional vehicle in which only a differential gear is mounted, which leads to driving vibration, aftershock, and deterioration in handling performance.

Furthermore, the weight of vehicle-mounted devices such as the motor and the reducer forming the PE system is much heavier than that of the differential gear, and a rear sub-frame of the electric vehicle has a double spring type fastened with a bush structure, which causes significant deterioration in performance.

Accordingly, efforts have been made to improve a rear PE mount used on the rear side of a vehicle. However, because a conventional bush type has a small pumping area, there is a disadvantage in that a damping size is not large and a dynamic characteristic is high. A conventional air damping mount structure has a very small damping value, and therefore it is required to provide an improved structure capable of increasing the damping value.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle mount including an improved air damping mount structure configured for increasing a damping effect.

The objects of the present disclosure are not limited to the above-mentioned objects, and other technical objects not mentioned herein will be clearly understood by those skilled in the art to which an exemplary embodiment of the present disclosure pertains (referred to hereinafter as “those skilled in the art”) from the detailed description of the embodiments.

Various aspects of the present disclosure are directed to providing a vehicle mount including an internal pipe coupled to a vehicle-mounted device, an insulator molded to be integrated with an external diameter portion of the internal pipe, wherein the insulator includes a stacked structure formed therein and configured to allow a plurality of chambers filled with fluid to be vertically spaced from each other, a flow path plate formed to provide a flow path configured to allow the fluid to be movable between the chambers in a state of being coupled to an external peripheral surface of the insulator and sealing the chambers including the stacked structure, and configured to surround the insulator and the flow path plate and coupled to a vehicle body side portion.

Other aspects and exemplary embodiments of the present disclosure are discussed infra.

It is understood that the terms “vehicle”, “vehicular”, and other similar terms as used herein are inclusive of motor vehicles in general, such as passenger vehicles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 s a view showing a conventional mount:

FIG. 2 is a perspective view showing an assembled mount according to various exemplary embodiments of the present disclosure:

FIG. 3 is an exploded perspective view showing a configuration of the mount according to the exemplary embodiment of the present disclosure:

FIG. 4 is a cross-sectional view taken along line “A-A” in FIG. 2:

FIG. 5 is a perspective view showing a flow path plate for an air damping mount according to the exemplary embodiment of the present disclosure:

FIG. 6 is a perspective view showing an internal pipe and a fork portion in the mount according to the exemplary embodiment of the present disclosure:

FIG. 7 is a view showing a mount without the fork portion on the internal pipe as an exemplary embodiment of the present disclosure:

FIG. 8 is a perspective view showing a state in which an insulator is coupled to the internal pipe and the fork portion in the mount according to the exemplary embodiment of the present disclosure:

FIG. 9 is a perspective view showing a state in which the flow path plate is coupled to the external peripheral surface of the insulator in the mount according to the exemplary embodiment of the present disclosure:

FIG. 10 is a perspective view showing a flow path plate for a hydraulic mount according to the exemplary embodiment of the present disclosure:

FIG. 11, FIG. 12 and FIG. 13 are views showing an operating state of the mount according to the exemplary embodiment of the present disclosure: and

FIG. 14, FIG. 15 and FIG. 16 are views showing a manufacturing process of the mount according to the exemplary embodiment of the present disclosure.

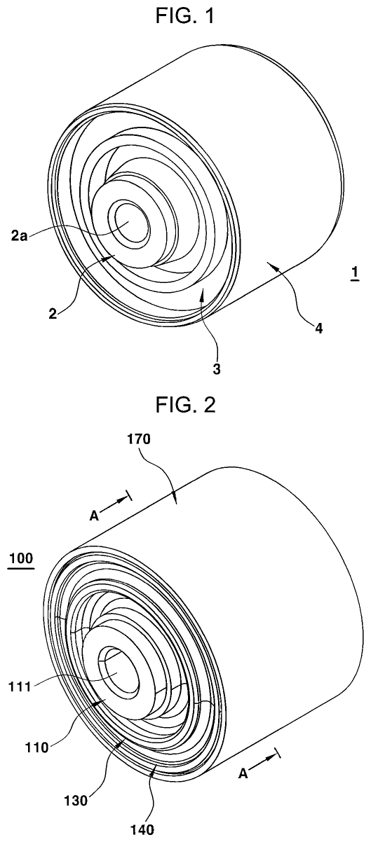

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particular intended application and use environment.

In the figures, reference numbers refer to the same or equivalent portions of the present disclosure throughout the several figures of the drawing.

### DETAILED DESCRIPTION

Hereinafter, various exemplary embodiments of the present disclosure will be described in detail with reference to the accompanying drawings. Specific structural or functional descriptions made in connection with the embodiments of the present disclosure are merely illustrative for describing embodiments according to the concept of the present disclosure, and the embodiments according to the concept of the present disclosure may be implemented in various forms. Furthermore, it will be understood that the present description is not intended to limit the present disclosure to the embodiments. On the other hand, the present disclosure is directed to cover not only the embodiments, but also various alternatives, modifications, equivalents, and other embodiments, which may be included within the spirit and scope of the present disclosure as defined by the appended claims.

Meanwhile, in an exemplary embodiment of the present disclosure, terms such as “first” and/or “second” may be used to describe various components, but the components are not limited by the terms. The terms are used only for distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe embodiments, and are not intended to limit the present disclosure. In the present specification, an expression in a singular form also includes a plural form, unless otherwise clearly specified in context. As used herein, expressions such as “comprise” and/or “comprising” do not exclude the presence or addition of one or more components, steps, operations, and/or elements other than those described.

Various embodiments of the present disclosure relate to a vehicle mount, and more particularly to a bush-type mount configured for being used in an electric vehicle. In detail, the mount according to an exemplary embodiment of the present disclosure may be a PE mount configured to mount a PE system including a motor and a reducer on a vehicle body side portion such as a sub-frame in an electric vehicle.

The mount according to an exemplary embodiment of the present disclosure may be a motor mount configured to mount a motor, which is a vehicle driving source in an electric vehicle, on a vehicle body side portion. Here, the vehicle body side portion may be a bracket of a sub-frame, that is, a bracket provided on the sub-frame of the vehicle body or formed to be integrated therewith.

Furthermore, the vehicle mount according to an exemplary embodiment of the present disclosure is a mount including an improved structure configured for increasing a damping effect, and as a main technical feature, the mount includes a stacked multi-chamber air damping mount structure.

In an exemplary embodiment of the present disclosure, air damping exhibits a damping action and a damping effect while air enters and exits a chamber. Furthermore, instead of the air damping mount structure, the vehicle mount according to an exemplary embodiment of the present disclosure may be configured as a hydraulic mount configured to exhibit a damping action and a damping effect while liquid fluid enters and exits a chamber to be filled therein or discharged therefrom. That is, the present disclosure may be provided as a stacked multi-chamber air damping mount or a stacked multi-chamber hydraulic mount.

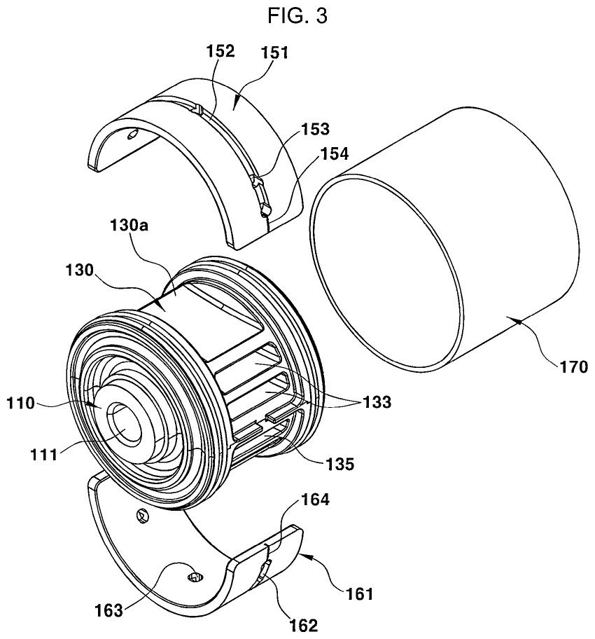

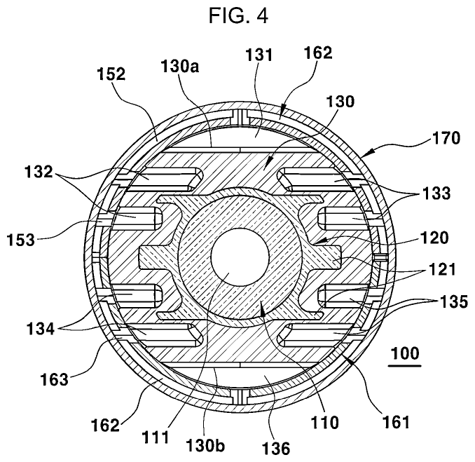

FIG. 2 is a perspective view showing an assembled mount according to various exemplary embodiments of the present disclosure, FIG. 3 is an exploded perspective view showing a configuration of the mount according to the exemplary embodiment of the present disclosure, and FIG. 4 is a cross-sectional view taken along line “A-A” in FIG. 2.

FIG. 4 shows a cross-sectional shape of the assembled mount taken in a transverse direction perpendicular to the axial direction. In the present specification, the “axial direction” of the mount is defined as a direction parallel to the central axis of a shaft insertion hole in an internal pipe 110.

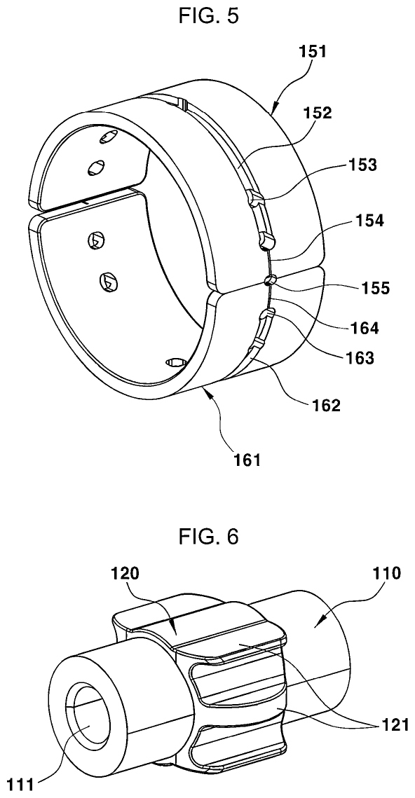

FIG. 5 is a perspective view showing a flow path plate for an air damping mount according to the exemplary embodiment of the present disclosure, and FIG. 6 is a perspective view showing an internal pipe and a fork portion in the mount according to the exemplary embodiment of the present disclosure.

As shown in FIG. 3, a vehicle mount 100 according to the exemplary embodiment of the present disclosure includes the internal pipe 110 coupled to a vehicle-mounted device such as a motor or a reducer forming a PE system, an insulator 130 integrally fixed on an external diameter portion of the internal pipe 110 by vulcanization molding, the insulator 130 including a plurality of chambers 131, 132, 133, 134, 135 and 136 disposed to be vertically stacked therein, an external pipe 170 assembled with and configured to surround the outside of the insulator 130 and coupled to a vehicle body side portion, and flow path plates 151 and 161 located between the insulator 130 and the external pipe 170, each of the flow path plates 151 and 161 providing a flow path configured to allow fluid to be movable between the chambers 131, 132, 133, 134, 135 and 136 of the insulator 130.

In the above-described configuration, the internal pipe 110 is also referred to as an “inner core”, and is formed to include a shaft insertion hole 111 disposed at an approximately center portion of the cross section thereof and configured to allow a bolt to pass therethrough.

The internal pipe 110 may be provided in a hollow pipe shape, and in the instant case, a hollow internal space of the internal pipe 110 becomes the shaft insertion hole 111. In the internal pipe 110, the shaft insertion hole 111 may be provided in a shape including a constant internal diameter in the axial direction (also referred to as the longitudinal direction) of the internal pipe.

The mount 100 according to the exemplary embodiment of the present disclosure further includes a fork portion 120 including a predetermined shape. Here, the fork portion 120 is provided in a state of being integrally coupled to the external peripheral surface of the internal pipe 110 and inserted into and disposed in the insulator 130.

The fork portion 120 may be formed to be integrated with the internal pipe 110. Alternatively, the fork portion 120 may be manufactured separately and then assembled to be integrally fixed to the internal pipe 110. For example, the internal pipe 110 and the fork portion 120 may be simultaneously molded to be integrally manufactured. Furthermore, the internal pipe 110 may be manufactured first, and the fork portion 120 may be molded on the internal pipe 110 to be integrated therewith through a separate process.

Alternatively, the internal pipe 110 including a certain cross-sectional shape is manufactured by extrusion molding using an aluminum alloy, and then the external peripheral surface of the internal pipe 110 may be bonded to the fork portion 120 manufactured separately, or may be fixed thereto by welding or the like.

Regarding the shape of the fork portion 120, when viewed from the cross section of the mount 100 and the internal pipe 110, the fork portion 120 may be provided in a vertically and horizontally symmetrical shape around the internal pipe 110, and the fork portion 120 includes a plurality of fork protrusions 121 formed to protrude from the internal pipe 110 toward the left and right sides of the internal pipe 110.

In the fork portion 120, the plurality of fork protrusions 121 may be formed to have wings disposed on the left and right sides of the internal pipe 110 and formed to protrude approximately in the horizontal direction thereof. Furthermore, the plurality of fork protrusions 121 are formed to be spaced from each other at predetermined intervals in the vertical direction, and the same number thereof may be formed on both the left and right sides of the internal pipe 110.

In a state in which the integral internal pipe 110 and the fork portion 120 are prepared, the insulator 130 is vulcanized and molded on the external diameter portion of the internal pipe 110 to surround the fork portion 120. In the instant case, the fork portion 120 is integrated with the insulator 130 in a state of being embedded in the insulator 130.

When the fork portion 120 is embedded in the insulator 130, each of the fork protrusions 121 of the fork portion 120 is embedded in a predetermined position in the insulator 130. Here, each of the wing-shaped fork protrusions 121 is inserted between the two adjacent chambers among the chambers 131, 132, 133, 134, 135 and 136 vertically stacked and spaced from each other at a predetermined distance in the insulator 130.

In the present structure, when an upper load or a lower load is applied through the internal pipe 110, each of the fork protrusions 121 of the fork portion 120 pressurizes a corresponding one of the chambers 131, 132, 133, 134, 135 and 136 of the insulator 130 respectively disposed above or below the fork protrusions 121. Thus, the fork portion 120 serves not only to increase pumping pressure for fluid (air or liquid fluid) in the chambers 131, 132, 133, 134, 135 and 136 but also to increase the damping size of the mount 100.

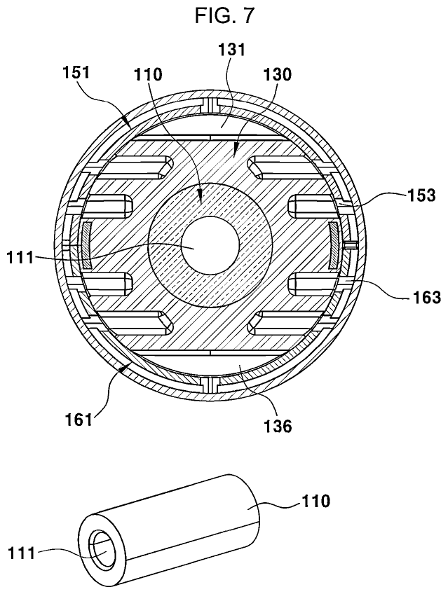

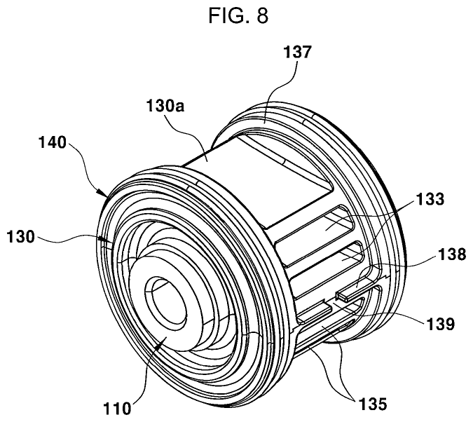

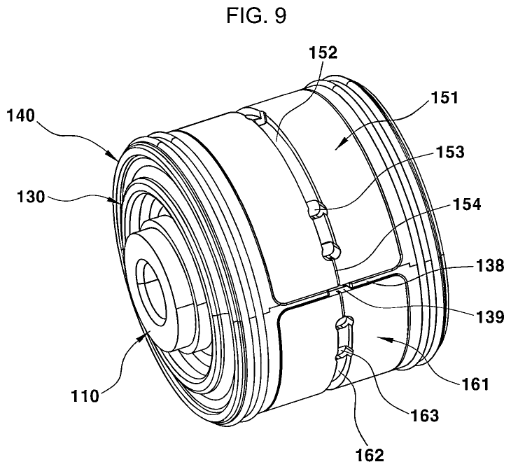

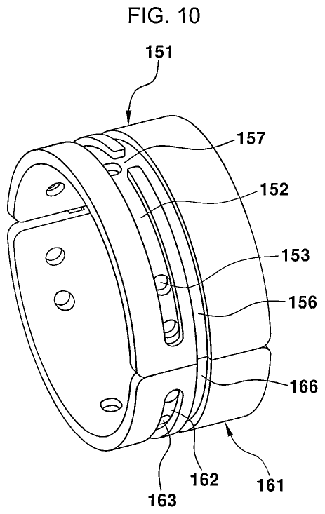

The fork portion 120 may be selectively applied to the internal pipe 110, and FIG. 7 shows an exemplary embodiment in which the internal pipe 110 does not include the fork portion 120. In the exemplary embodiment of FIG. 4, the fork portion 120 integrally fixed to the internal pipe 110 pressurizes the adjacent chambers 131, 132, 133, 134, 135 and 136 through the fork protrusions 121, but the mount 100 may be operated even if the fork portion 120 is not provided, as shown in FIG. 7.

Compared to a mount including the fork portion 120 configured to pressurize the chambers 131, 132, 133, 134, 135 and 136, a mount without the fork portion 120 is advantageous in terms of cost and weight, but has slight deterioration in damping performance. Furthermore, although the fork portion 120 serves to improve damping performance, the effect of increasing damping performance may be provided by a multi-chamber structure even if the fork portion 120 is not provided.

In the mount 100 according to the exemplary embodiment of the present disclosure, the external pipe 170 is provided with a circular cross-sectional shape, and the external pipe 170 is provided in a circular pipe shape including a predetermined diameter to be press-fitted into a mounting hole of a vehicle body side portion and to be fixed thereto.

In the mount 100 according to the exemplary embodiment of the present disclosure, the internal pipe 110 is a component coupled to a vehicle-mounted device such as a motor of the PE system, and the external pipe 170 is a component coupled to a vehicle body side portion such as a sub-frame.

The insulator 130 is also referred to as “rubber”, and may be formed by vulcanizing rubber and molding the rubber into a predetermined shape to include a structure surrounding the internal pipe 110 and the fork portion 120.

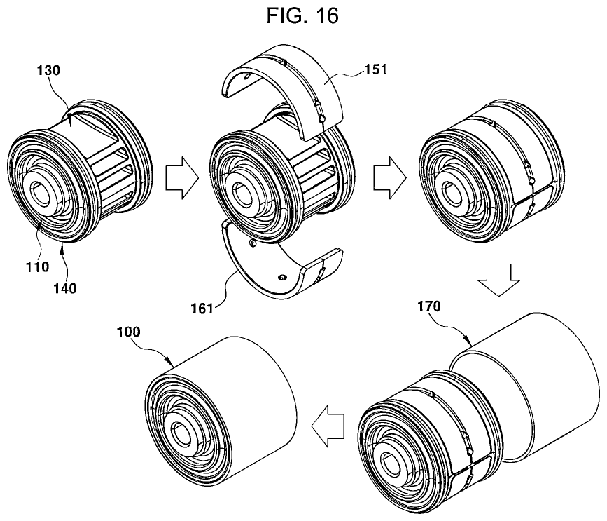

Here, the insulator 130 may be molded so that the fork portion 120 and a frame (reference numeral “140” in FIG. 14) are integrally fixed in a state of being embedded in the insulator 130. The frame 140 is configured as a framework configured to maintain and support the overall shape of the insulator 130 in a state of being embedded in the insulator 130.

In the state in which the insulator 130 is molded as described above, a pair of flow path plates 151 and 161 is attached to the external peripheral surface of the insulator 130 to seal the chambers 131, 132, 133, 134, 135 and 136. Each of the flow path plates 151 and 161 may be manufactured to include a semicircular shape. When the two flow path plates 151 and 161 are coupled to each other to be in close contact with the external peripheral surface (circumferential surface) of the insulator 130, the two flow path plates 151 and 161 surround the entire external peripheral surface of the insulator 130 in a circular shape.

Furthermore, when the flow path plates 151 and 161 are attached to the external peripheral surface of the insulator 130 formed to be integrated with the internal pipe 110 and the fork portion 120, the flow path plates 151 and 161 respectively seal the chambers 131, 132, 133, 134, 135 and 136 by closing respective fluid inlets/outlets of the chambers 131, 132, 133, 134, 135 and 136. Here, each of the fluid inlets/outlets is located on the external peripheral surface of the insulator 130.

Accordingly, the assembled internal pipe 110, the fork portion 120, the insulator 130, and the flow path plates 151 and 161 are inserted into and coupled to the external pipe 170. After coupling, the external peripheral surfaces of the flow path plates 151 and 161 are in close contact with the internal peripheral surface of the external pipe 170.

Accordingly, after the mount 100 is assembled, the insulator 130 is located between the internal pipe 110 and the external pipe 170, and the flow path plates 151 and 161 are located between the external peripheral surface of the insulator 130 and the internal peripheral surface of the external pipe 170.

In the mount 100, the insulator 130 is a component configured to integrally couple and fix the internal pipe 110 to the external pipe 170 and to perform a function of vibration isolation therebetween, and the same is coupled to the external peripheral surface of the internal pipe 110 and the external surface of the fork portion 120 by vulcanization molding to be integrally fixed thereto.

FIG. 8 is a perspective view showing a state in which the insulator is coupled to the internal pipe and the fork portion in the mount according to the exemplary embodiment of the present disclosure, and FIG. 9 is a perspective view showing a state in which the flow path plate is coupled to the external peripheral surface (circumferential surface) of the insulator in the mount according to the exemplary embodiment of the present disclosure.

The insulator 130 formed to surround the internal pipe 110 and the fork portion 120 includes a symmetrical cross-sectional shape in the vertical and horizontal directions (refer to FIG. 4). Furthermore, in the insulator 130, a plurality of chambers 131, 132, 133, 134, 135 and 136 are formed to be vertically stacked and disposed in a state of being spaced from each other at a predetermined distance. For example, the chambers 132 and 134 including four chambers and the chambers 133 and 135 including four chambers may be disposed to be vertically stacked on the left side and the right side in cross section, respectively.

In the instant case, the insulator 130 may include a horizontally symmetrical shape on the cross section of the mount 100. Accordingly, the chambers 132 and 134 including four chambers on the left side of the insulator and the chambers 133 and 135 including four chambers on the right side thereof may be provided in the same shape and at the same interval.

Similarly, the insulator 130 may include a vertically symmetrical shape on the cross section of the mount 100. Accordingly, the left and right upper chambers 132 and 133 including four chambers (two chambers on the upper left side and two chambers on the upper right side) and the left and right lower chambers 134 and 135 including four chambers (two chambers on the lower left side and two chambers on the lower right side) are provided in the same shape and at the same intervals.

Furthermore, referring to FIG. 4, on the cross section of the mount 100, the left fork protrusion 121 of the fork portion 120 is inserted and disposed between two adjacent left chambers 132 and 134 of the insulator 130. Similarly, referring to FIG. 4, on the cross section of the mount 100, the right fork protrusion 121 of the fork portion 120 is inserted and disposed between two adjacent right chambers 133 and 135 of the insulator 130.

Furthermore, as shown in FIG. 4, on the cross section of the mount 100, the chambers 132 and 134 including a total of four chambers may be disposed only on the left side thereof. In more detail, two chambers are disposed on the upper left side and two chambers are disposed on the lower left side thereof. Furthermore, on the cross-section of the mount 100, the chambers 133 and 135 including a total of four chambers may be disposed only on the right side thereof. In more detail, two chambers are disposed on the upper right side and two chambers are disposed on the lower right side thereof.

In the exemplary embodiment of the present disclosure, each of the chambers 131, 132, 133, 134, 135 and 136 may be provided by forming a chamber groove including a predetermined depth on the external peripheral surface (circumferential surface) of the insulator 130. Each of the chamber grooves of the chambers 132, 133, 134 and 135 located on the left and right sides includes a shape extending in the horizontal direction thereof.

Each of the chamber grooves forming the chambers 132, 133, 134 and 135 disposed on the opposite sides includes an open shape on the external peripheral surface (circumferential surface) of the insulator 130. An opening of each chamber groove located on the external peripheral surface of the insulator 130 is configured as a fluid inlet/outlet configured to allow air or liquid fluid to enter and exit each of the chambers 132 and 135.

Additionally, separate chamber grooves 130a and 130b formed to be recessed to a predetermined depth are formed at the upper end portion of the insulator 130 and the lower end portion thereof, respectively. When the first flow path plate 151 of the pair of flow path plates 151 and 161 is tightly coupled to the upper portion of the external peripheral surface (circumferential surface) of the insulator 130, the chamber groove 130a of the upper portion of the insulator 130 and the first flow path plate 151 covering the chamber groove 130a form the upper chamber 131, which is a separate sealed chamber.

Similarly, when the second flow path plate 161 of the pair of flow path plates 151 and 161 is tightly coupled to the lower portion of the external peripheral surface (circumferential surface) of the insulator 130, the chamber groove 130b at the lower end portion of the insulator 130 and the second flow path plate 161 covering the chamber groove 130b form the lower chamber 136, which is a sealed separate chamber.

Accordingly, in the illustrated exemplary embodiment of the present disclosure, the chambers 131, 132, 133, 134, 135 and 136 including a total of 10 chambers sealed by the flow path plates 151 and 161 are provided in the insulator 130. That is, the chambers 131, 132, and 133 including five chambers are provided at the upper portion of the mount 100, and the chambers 134, 135, and 136 including five chambers are provided at the lower portion of the mount 100.

In the following description, the upper chambers 131, 132, and 133 including five chambers on the cross section of the mount 100 will be referred to as “upper chambers”, and the lower chambers 134, 135, and 136 including five chambers will be referred to as “lower chambers”.

In the illustrated exemplary embodiment of the present disclosure, although the chambers 131, 132, 133, 134, 135 and 136 including a total of 10 chambers are provided, the number of chambers is exemplary and the present disclosure is not limited thereto. The number of chambers 131, 132, 133, 134, 135 and 136 may be variously changed.

For example, a total of 12 chambers may be provided on the cross section of the mount. On the cross section of the mount, five chambers on the left side, five chambers on the right side, one chamber on the upper side, and one chamber on the lower side may be provided in the mount. Alternatively, the number of chambers may be greater than 12 or less than 10.

On the cross section of the mount 100, each of the chamber grooves respectively forming the left and right chambers 132, 133, 134 and 135 is formed in a shape including a predetermined depth (a predetermined length in the horizontal direction in the drawing) on the surface of the insulator. In the instant case, the upper and lower surfaces inside each of the chambers 132, 133, 134 and 135 may be formed in parallel to each other as horizontal planes.

Furthermore, as described above, the chamber grooves 130a and 130b are formed to be recessed and respectively formed at the upper end portion of the insulator 130 and the lower end portion thereof, forming the upper chamber 131 and the lower chamber 136. Here, the lower surfaces of the chamber grooves 130a and 130b may be formed as flat surfaces, and may be formed to have surface shapes parallel to the upper and lower surfaces inside the chambers 132, 133, 134 and 135 on the left and right sides (refer to FIGS. 3, 4, and 7).

The flow path plates 151 and 161 are components configured to seal the chambers 131, 132, 133, 134, 135 and 136 of the insulator 130 in a state of being located between the insulator 130 and the external pipe 170 and to provide a flow path through which fluid (air or liquid fluid) is movable between the chambers 131, 132, 133, 134, 135 and 136.

As described above, when the pair of semicircular flow path plates 151 and 161 is in close contact with the external peripheral surface (circumferential surface) of the insulator 130, the two flow path plates 151 and 161, that is, the first flow path plate 151 and the second flow path plate 161 are combined to form an overall circular shape on the external peripheral surface of the insulator 130.

FIG. 5 shows a pair of flow path plates 151 and 161 coupled to each other in a circular shape, and the flow path plates 151 and 161 shown in FIG. 5 may be used in an air damping mount. As shown in the drawing, the flow path plates 151 and 161 have main flow paths 152 and 162 respectively formed on the external peripheral surfaces thereof. Here, each of the main flow paths 152 and 162 is disposed at an approximately central position of the external peripheral surface in the width direction, extends in the longitudinal direction (which may be the circumferential direction) of the flow path plate, and includes a predetermined depth and width.

The main flow paths 152 and 162 are respectively disposed on the external peripheral surfaces of the flow path plates 151 and 161 and formed by allowing respective flow path grooves, each of the flow path grooves including a predetermined depth and width, to extend in the longitudinal direction (circumferential direction) of the two flow path plates. The main flow paths 152 and 162 have flow path holes 153 and 163 respectively formed to penetrate the bottom surfaces thereof and configured to allow fluid to be movable between the chambers 131, 132, 133, 134, 135 and 136 formed in the insulator 130 and the main flow paths 152 and 162.

In the flow path plates 151 and 161, the flow path holes 153 and 163 are formed to be disposed at a predetermined interval along the main flow paths 152 and 162. Here, as shown in FIG. 4, the main flow paths 152 and 162 include the flow path holes 153 and 163 respectively formed on the bottom surfaces thereof, and each of the flow path holes 153 and 163 is disposed at a position corresponding to each of the openings provided as the fluid inlets/outlets of the respective chambers 131, 132, 133, 134, 135 and 136 provided in the insulator 130.

Referring to FIG. 4, because the insulator 130 includes the chambers 131, 132, 133, 134, 135 and 136 including 10 chambers, the flow path holes 153 and 163 including a total of 10 flow path holes are formed in the flow path plates 151 and 161, and each of the flow path holes 153 and 163 is disposed at a position corresponding to each of the openings of the chamber 131, 132, 133, 134, 135 and 136.

A total of 10 flow path holes 153 and 163 is formed in the cross section of the mount 100. Four flow path holes on the left side, four flow path holes on the right side, one flow path hole on the upper end portion, and one flow path hole on the lower end portion are formed in the mount 100. The number of flow path holes is exemplary, and the present disclosure is not limited thereto. The number of flow path holes 153 and 163 in the flow path plates 151 and 161 may be variously changed.

In FIG. 5, reference numerals “154” and “164” denote connection flow paths respectively formed on the external peripheral surfaces of the opposite end portions of the flow path plates 151 and 161. The inside of each of the connection flow paths 154 and 164 is connected to a corresponding one of the main flow paths 152 and 162, enabling fluid to be movable therebetween.

As an exemplary embodiment of the present disclosure, the connection flow paths 154 and 164 may be provided on the external peripheral surfaces of the opposite end portions of the respective flow path plates 151 and 161 and formed by allowing respective flow path grooves, each of the flow path grooves including a predetermined width and depth, to extend in the longitudinal direction (circumferential direction) of the flow path plates from the main flow paths 152 and 162 to the end surfaces of the flow path plates 151 and 161. In the instant case, each of the connection flow paths 154 and 164 may be provided in a form of a micro flow path including a smaller flow path width and a smaller flow path cross-sectional area than those of the main flow paths 152 and 162.

In the mount 100 according to the exemplary embodiment of the present disclosure, when the pair of flow path plates 151 and 161 is combined to be disposed in a circular shape on the external peripheral surface of the insulator 130 (refer to FIG. 9), each connection flow path 154 of the first flow path plate 151 is connected to each connection flow path 164 of the second flow path plate 161, allowing air to be movable therebetween.

As a result, air, discharged from the upper chambers 131, 132, and 133 of the insulator 130 and moved to the main flow path 152 of the first flow path plate 151 through the respective flow path holes 153, may flow along the main flow path 152. Thereafter, the air may be moved to the main flow path 162 of the second flow path plate 161 through the connection flow path 154.

In the present manner, the air moved to the main flow path 162 of the second flow path plate 161 may flow along the main flow path 162. Thereafter, the air may be moved to the lower chambers 134, 135, and 136 of the insulator 130 through the respective flow path holes 163.

Conversely, air, discharged from the lower chambers 134, 135, and 136 of the insulator 130 and moved to the main flow path 162 of the second flow path plate 161 through the respective flow path hole 163, may flow along the main flow path 162. Thereafter, the air may be moved to the main flow path 152 of the first flow path plate 151 through the connection flow path 164. In the present manner, the air moved to the main flow path 152 of the first flow path plate 151 may flow along the main flow path 152. Thereafter, the air may be moved to the upper chambers 131, 132, and 133 of the insulator 130 through the respective flow path holes 153.

In the present manner, each of the flow paths of the flow path plates 151 and 161 may be used as a flow path configured to allow air (or liquid fluid) to be movable between the chambers 131, 132, 133, 134, 135 and 136. Each of the flow path plates 151 and 161 may provide a flow path configured to allow air to be movable between the upper chambers 131, 132, and 133 and the lower chambers 134, 135, and 136.

Among the chambers 131, 132, 133, 134, 135 and 136 including a total of 10 chambers in the mount 100 according to an exemplary embodiment of the present disclosure, the upper chambers 131, 132, and 133 including five chambers, and the lower chambers 134, 135, and 136 including five chambers are provided. Here, the upper chambers 131, 132, and 133 are simultaneously pressurized and compressed, or the lower chambers 134, 135, and 136 are simultaneously pressurized and compressed.

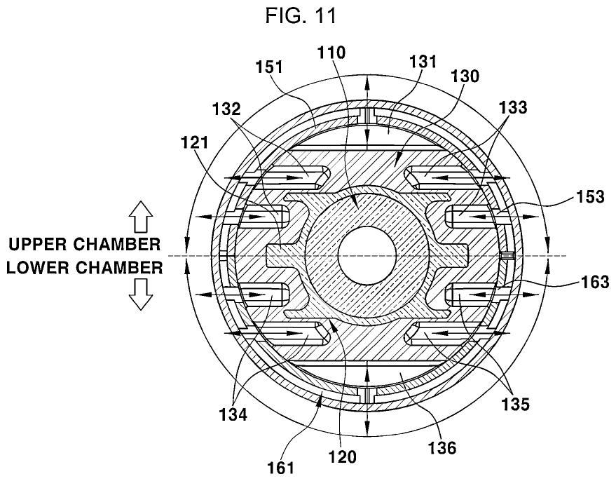

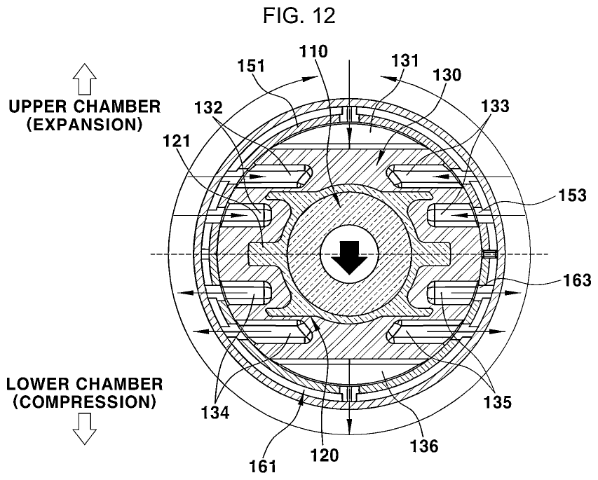

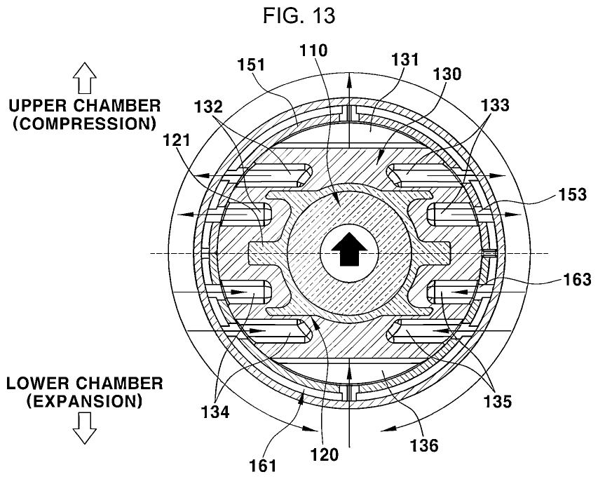

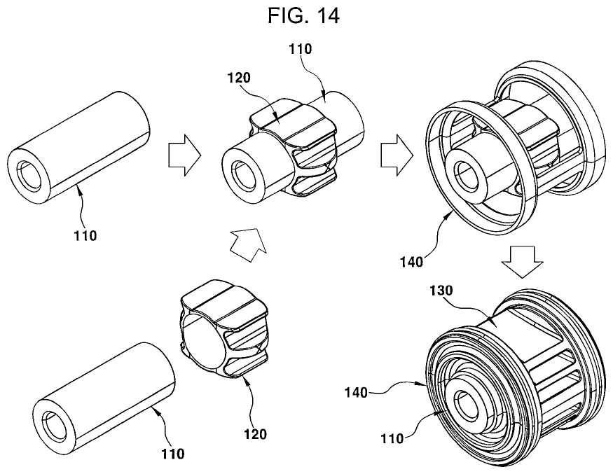

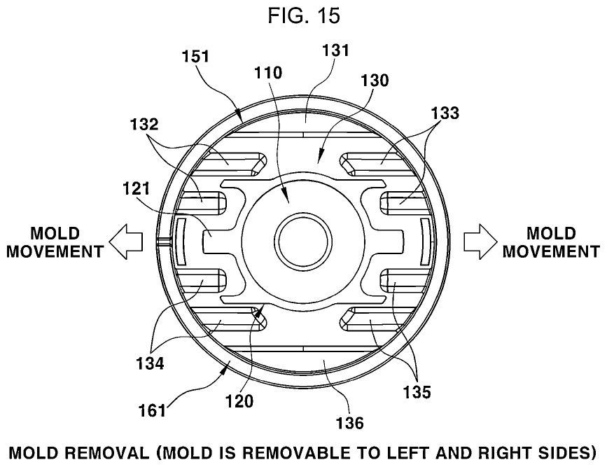

FIG. 11, FIG. 12 and FIG. 13 are views showing the operating state of the mount according to the exemplary embodiment of the present disclosure, FIG. 12 shows a state in which a downward load is applied to the mount 100 through the internal pipe 110, and FIG. 13 shows a state in which an upward load is applied to the mount 100 through the internal pipe 110.

When a load is input downwards through the internal pipe 110 of the mount 100, the lower chambers 134, 135, and 136 are simultaneously compressed by the fork portion 120 (or the internal pipe itself) of the internal pipe 110. When the lower chambers 134, 135, and 136 are compressed, fluid in the lower chambers moves into the upper chambers 131, 132, and 133 through the flow paths of the flow path plates 151 and 161 to simultaneously expand the upper chambers (refer to FIG. 12).

Conversely, when a load is input upwards through the internal pipe 110 of the mount 100, the upper chambers 131, 132, and 133 are simultaneously compressed by the fork portion 120 (or the internal pipe itself) of the internal pipe 110. When the upper chambers 131, 132, and 133 are compressed, fluid in the upper chambers moves into the lower chambers 134, 135, and 136 through the flow paths of the flow path plates 151 and 161 to simultaneously expand the lower chambers (refer to FIG. 13).

As described above, fluid discharged from the plurality of chambers 131 to 133 that are simultaneously compressed moves to the plurality of opposite chambers 134 to 136 to simultaneously expand the opposite chambers. Here, damping is performed by a process in which fluid filled in the simultaneously compressed chambers moves to the opposite chambers to simultaneously expand the opposite chambers.

As a result, in the conventional rubber mount, while a rubber insulator is compressed vertically, a dynamic characteristic deteriorates in the direction of compression. On the other hand, in the mount 100 according to the exemplary embodiment of the present disclosure, the rubber insulator 130 moves in the shear direction by applying the stacked multi-chamber structure thereto. Accordingly, a dynamic characteristic of the mount 100 in an exemplary embodiment of the present disclosure is lower than that of the conventional mount 100 (low dynamic magnification, “dynamic magnification =dynamic characteristics/static characteristics”), and furthermore to an effect of improving the dynamic characteristics, there is an advantage in terms of durability.

In the mount 100 according to an exemplary embodiment of the present disclosure, the main flow path 152 of the first flow path plate 151 is a flow path including a large cross-sectional area configured to connect the upper chambers 131, 132, and 133 of the insulator 130 and to allow air to be movable therebetween, and the main flow path 162 of the second flow path plate 161 is a flow path including a large cross-sectional area configured to connect the lower chambers 134, 135, and 136 of the insulator 130 and to allow air to be movable therebetween.

In the instant case, the connection flow path 154 of the first flow path plate 151 and the connection flow path 164 of the second flow path plate 161 are flow paths, each of the flow paths including a small cross-sectional area, configured to connect the main flow path 152 of the first flow path plate 151 to the main flow path 162 of the second flow path plate 161 and to connect the upper chambers 131, 132, and 133 to the lower chambers 134, 135, and 136, allowing air to be movable therebetween.

As described above, in the mount 100 according to an exemplary embodiment of the present disclosure, although the upper chambers 131, 132, and 133 including five chambers or the lower chambers 134, 135, and 136 including five chambers are simultaneously operated to perform the same function of compression or expansion, the upper chambers 131, 132, and 133 and the lower chambers 134, 135, and 136 are divided into a plurality of chambers, making it possible to increase a pumping area.

Accordingly, in the mount 100 according to an exemplary embodiment of the present disclosure, a structure including the stacked chambers 131, 132, 133, 134, 135 and 136 in which air or liquid fluid is filled is applied to the insulator 130, making it possible not only to increase an area inside the chambers 131, 132, 133, 134, 135 and 136 but also to increase a pumping area.

Furthermore, a plurality of chambers 131, 132, 133, 134, 135 and 136 configured for being simultaneously compressed or expanded at the upper and lower portions of the insulator and providing a large moving amount of fluid (air or liquid fluid) are disposed in the mount 100 according to an exemplary embodiment of the present disclosure. Accordingly, when fluid is compressed, compressive force may be increased compared to the conventional mount, and through the present configuration, it is possible to obtain an effect of greatly increasing a damping value.

Hereinabove, a flow path plate of an air damping mount using air as fluid has been described. The present disclosure may be provided as a hydraulic mount using liquid fluid, and FIG. 10 is a perspective view showing flow path plates 151 and 161 applicable to a hydraulic mount as another exemplary embodiment of the present disclosure.

As shown in the drawing, as in the case of the flow path plate for the air damping mount, the main flow paths 152 and 162 and the flow path holes 153 and 163 are also formed on the external peripheral surfaces of the flow path plates 151 and 161 for the hydraulic mount. However, the flow path plates 151 and 161 have separate damping flow paths 156 and 166 respectively formed on the external peripheral surfaces thereof and disposed in a direction parallel to the main flow paths 152 and 162 instead of providing the connection flow paths 154 and 164 each including a small cross-sectional area.

As in the case of the main flow paths 152 and 162, the damping flow paths 156 and 166 may be formed by allowing flow path grooves, each of the flow path grooves including a predetermined width and depth, to be respectively formed on the external peripheral surfaces of the flow path plates 151 and 161 and to extend in the longitudinal direction (which may be the circumferential direction) of the flow path plates.

In the instant case, the width of each of the damping flow paths 156 and 166 may be set to be substantially similar to or slightly smaller than the width of each of the main flow paths 152 and 162. Accordingly, as in the case of the main flow paths 152 and 162, each of the damping flow paths 156 and 166 may be provided as a flow path including a large cross-sectional area.

When the damping flow paths 156 and 166 are formed over the entire external peripheral surfaces of the respective flow path plates 151 and 161, and the pair of flow path plates 151 and 161 is combined in a circular shape, the damping flow paths 156 and 166 of the two flow path plates 151 and 161 form an annular flow path that are continuously connected to each other in a circular shape.

Furthermore, each of the flow path plates 151 and 161 includes a fluid flow path 157 provided on the external peripheral surface thereof and configured to connect the main flow paths 152 and 162 to the damping flow paths 156 and 166. Accordingly, the fluid flow path 157 fluidically-communicating between the main flow paths 152 and 162 and the damping flow paths 156 and 166 may be provided singularly or in plural.

Accordingly, when fluid discharged from a portion of the chambers 131, 132, 133, 134, 135 and 136 on one side of the insulator 130 flows into one of the main flow paths 152 and 162 through one of the flow path holes 153 and 163 of the two flow path plates 151 and 161, the fluid may be combined in the main flow paths 152 and 162 and then moved to one of the damping flow paths 156 and 166 through the fluid flow path 157.

Furthermore, after the fluid flowing along one of the damping flow paths 156 and 166 is moved to the other one of the damping flow paths 156 and 166 of the two flow path plates 151 and 161, the fluid may be moved to the other one of the main flow paths 152 and 162 through the fluid flow path 157 of the flow path plates 151 and 161. Thereafter, the fluid may be moved to each of a portion of the chambers 131, 132, 133, 134, 135 and 136 on the other side of the insulator 130 again through the other one of the flow path holes 153 and 163.

The fluid flow path 157 may be formed by removing a portion of the flow path plate, the portion provided as a wall portion located between the main flow paths 152 and 162 and the damping flow paths 156 and 166, that is, the same may be formed by a method of forming a groove in at least a portion of the portion of the flow path plate provided as the wall portion.

In the present manner, in the case of a hydraulic mount as well, when a load is applied upwards through the internal pipe 110, the upper chambers 131, 132, and 133 are simultaneously compressed. Here, when the upper chambers 131, 132, and 133 are compressed, fluid in the upper chambers sequentially passes through the flow path hole 153 of the first flow plate 151, the main flow path 152, the fluid flow path 157, the damping flow path 156, and the damping flow path 166 of the second flow path plate 161, the fluid flow path, and the main flow path 162. Thereafter, the fluid flows into each of the lower chambers 134, 135, 136 through the flow path hole 163 and simultaneously expands the lower chambers 134, 135 and 136.

Conversely, when a load is applied downwards through the internal pipe 110, the lower chambers 134, 135, and 136 are simultaneously compressed. Here, when the lower chambers 134, 135, and 136 are compressed, fluid in the lower chambers sequentially passes through the flow path hole 163 of the second flow plate 161, the main flow path 162, the fluid flow path, the damping flow path 166, and the damping flow path 156 of the first flow path plate 151, the fluid flow path 157, and the main flow path 152. Thereafter, the fluid flows into each of the upper chambers 131, 132, 133 through the flow path hole 153 and simultaneously expands the upper chambers 131, 132 and 133.

A connection hole 155 considering assembly tolerance may be formed at the end portions of the connection flow paths 154 and 164 in the first flow path plate 151 and the second flow path plate 161 in FIG. 5. The connection hole 155 may be provided by forming a groove disposed between the end surfaces of the flow path plates 151 and 161 and connected to the connection flow paths 154 and 164. Here, the groove includes a larger width than that of each of the connection flow paths 154 and 164.

Accordingly, when two flow path plates 151 and 161 are assembled, even if the positions of the connection flow paths 154 and 164 of the flow path plates 151 and 161 disposed on the opposite sides do not coincide with each other and deviate from each other, the connection flow paths 154 and 164 of the two flow path plates 151 and 161 may fluidically-communicate with each other to allow air to be movable therebetween through the connection hole 155 including a relatively wide width.

As an exemplary embodiment of the present disclosure, referring to FIG. 8 and FIG. 9, the insulator 130 includes a recessed groove 137 formed on the external peripheral surface thereof and configured to allow the flow path plates 151 and 161 to be inserted thereinto and accommodated thereon, and as such the flow path plates 151 and 161 may be inserted into and coupled to the groove 137.

In the instant case, when the insulator 130 is molded, the insulator 130 includes a rubber film 138 formed on the external peripheral surface thereof and configured to extend in the axial direction thereof, and the rubber film 138 includes an opening 139 located at a center portion thereof and formed by removing a portion of the rubber film 138.

The rubber film 138 is formed to absorb tolerance when the first flow path plate 151 and the second flow path plate 161 are assembled with each other. Furthermore, the rubber film 138 is located between the end surface of the first flow path plate 151 and the end surface of the second flow path plate 161 and formed to protrude to allow the end surfaces of the two flow path plates 151 and 161 to be in close contact with the rubber film 138.

Furthermore, the opening 139 formed at the center portion of the rubber film 138 is a part configured to fluidically-communicate between the connection flow paths 154 and 164 of both flow path plates in a state in which the flow path plates 151 and 161 are assembled with each other. Furthermore, the opening 130 is a part provided as a passage through which fluid is movable between the connection flow paths 154 and 164.

FIG. 14, FIG. 15 and FIG. 16 are views showing a manufacturing process of the mount according to the exemplary embodiment of the present disclosure. FIG. 14, and FIG. 15 are views showing a manufacturing process of allowing the insulator 130 to be integrally coupled to the internal pipe 110 among the components of the mount 100.

As shown in FIG. 14, the internal pipe 110 and the fork portion 120 are molded to be integrated with each other, or after the internal pipe 110 and the fork portion 120 are separately manufactured, the fork portion 120 is assembled on the external peripheral surface of the internal pipe 110.

Accordingly, after the internal pipe 110, the fork portion 120, and the frame 140 are provided in the mold, the insulator 130 may be formed by vulcanizing and molding a rubber raw material. Accordingly, the insulator 130 formed to be integrated with the internal pipe 110, the fork portion 120, and the frame 140 may be manufactured.

Because the internal surface and the internal space of each of the chambers 131. 132, 133, 134, 135 and 136 in the insulator 130 are formed in the left-and-right direction, it is possible to remove the mold from the insulator 130 in the left-and-right direction after the insulator 130 is molded (the mold is removable to the left and right sides, refer to FIG. 15).

Thereafter, as shown in FIG. 16, after the first flow path plate 151 and the second flow path plate 161 are respectively assembled on the upper and lower sides of the external peripheral surface (circumferential surface) of the insulator 130, the insulator 130 in a state where the flow path plates 151 and 161 are assembled with each other is inserted into the external pipe 170.

In an exemplary embodiment of the present disclosure, the flow path plates 151 and 161 may be made of metal such as an aluminum alloy or a synthetic resin. Furthermore, in the state in which the flow path plates 151 and 161 are assembled with each other, the insulator 130 is inserted into the external pipe 170 and then coupled and fixed to the external pipe 170 by a swaging process, sealing the flow paths of the flow path plates 151 and 162 and the chambers 131, 132, 133, 134, 135 and 136 of the insulator 130.

In the present manner, the vehicle mount according to the exemplary embodiment of the present disclosure has been described in detail. The vehicle mount of the present disclosure includes a multi-chamber damping structure in which a plurality of chambers are vertically stacked in an insulator (rubber), making it possible to increase a pumping area, a damping value, and a damping size as compared with a conventional bush-type mount.

Furthermore, according to an exemplary embodiment of the present disclosure, it is possible to implement both a hydraulic mount and an air damping mount by adjusting a flow path length of a flow path plate and a cross-sectional area thereof. A stacked structure is applied to a bridge of the insulator, making it possible to improve durability of a single product and dynamic characteristics.

Furthermore, because the insulator is configured to move in the shear direction in the compressed state, durability of the mount may be improved, and dynamic characteristics may be improved, reducing noise, vibration, and harshness (NVH) (whine noise).

As is apparent from the above description, various aspects of the present disclosure are directed to providing a vehicle mount according to an exemplary embodiment of the present disclosure including a multi-chamber damping structure in which a plurality of chambers are vertically stacked in an insulator (rubber). Accordingly, it is possible to increase a pumping area, a damping value, and a damping size as compared with a conventional bush-type mount.

Additionally, according to an exemplary embodiment of the present disclosure, a flow path length of a flow path plate and a cross-sectional area thereof are adjusted, making it possible to implement both a hydraulic mount and an air damping mount. A stacked structure is applied to a bridge of the insulator, improving durability of a single product and dynamic characteristics.

Furthermore, because the insulator is configured to move in the shear direction when the insulator is compressed, durability performance of the mount may be improved, and dynamic characteristics may be improved. Accordingly, it is possible to reliably reduce NVH (whine noise).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle mount comprising:
an internal pipe coupled to a vehicle-mounted device:
an insulator molded to be integrated with the internal pipe, wherein the insulator includes a stacked structure formed therein and configured to allow a plurality of chambers filled with a fluid to be vertically spaced from each other;
a flow path plate formed to provide a flow path configured to allow the fluid to be movable between the chambers in a state of being coupled to an external peripheral surface of the insulator and sealing the chambers including the stacked structure; and
an external pipe coupled to and configured to surround the insulator and the flow path plate and coupled to a vehicle body side portion.

2. The vehicle mount of claim 1, further including a fork portion provided in a state of being coupled to the internal pipe, the fork portion including fork protrusions, each of the fork protrusions pressurizing a corresponding one of the chambers in a state of being embedded in the insulator.

3. The vehicle mount of claim 2, wherein the fork portion includes a horizontally symmetrical shape on a cross section of the mount, the cross section being taken in a transverse direction perpendicular to an axial direction of the internal pipe.

4. The vehicle mount of claim 3, wherein the fork portion further includes a plurality of fork protrusions respectively formed on a left side of the fork portion and a right side thereof on the cross section of the mount.

5. The vehicle mount of claim 4,
wherein the insulator includes a horizontally symmetrical shape on the cross section of the mount,
wherein the insulator includes a stacked structure formed therein and configured to allow the plurality of chambers to be vertically spaced from each other on a left side of the insulator and a right side thereof, and
wherein each of the fork protrusions is disposed to be located between the chambers vertically spaced from each other.

6. The vehicle mount of claim 5,
wherein the insulator includes a vertically symmetrical shape on the cross section of the mount, and
wherein the plurality of chambers include:
a plurality of upper chambers formed to be disposed on an upper left side of the insulator and an upper right side thereof on the cross section of the mount: and
a plurality of lower chambers formed to be disposed on a lower left side of the insulator and a lower right side thereof on the cross section of the mount.

7. The vehicle mount of claim 6, wherein the fork portion further includes a vertically symmetrical shape on the cross section of the mount.

8. The vehicle mount of claim 2,
wherein the insulator includes a vertically symmetrical shape on a cross section of the mount, and
wherein the plurality of chambers include:
a plurality of upper chambers formed to be disposed on an upper portion of the insulator on the cross section of the mount: and
a plurality of lower chambers formed to be disposed on a lower portion of the insulator on the cross section of the mount.

9. The vehicle mount of claim 8,
wherein the fork portion includes a plurality of fork protrusions, and
wherein each of the fork projections is disposed to be located between the chambers vertically spaced from each other in the insulator.

10. The vehicle mount of claim 9, wherein the fork portion further includes a vertically symmetrical shape on the cross section of the mount.

11. The vehicle mount of claim 1,
wherein the insulator includes a vertically and horizontally symmetrical shape on a cross section of the mount, the cross section being taken in a transverse direction perpendicular to an axial direction of the internal pipe, and
wherein the insulator includes a stacked structure formed therein and configured to allow the plurality of chambers to be vertically spaced from each other on an upper portion of the insulator and a lower portion of the insulator.

12. The vehicle mount of claim 11,
wherein each of the chambers of the insulator is provided by forming a chamber groove in the external peripheral surface of the insulator, the chamber groove including a predetermined width and depth, and
wherein each of the chambers includes a fluid inlet/outlet disposed on the external peripheral surface of the insulator and configured to allow the fluid to enter and exit between the chamber and the flow path of the flow path plate.

13. The vehicle mount of claim 12, wherein the plurality of chambers are formed in a direction extending horizontally on the cross section of the mount, wherein the chambers form the stacked structure at the upper portion of the insulator and the lower portion of the insulator.

14. The vehicle mount of claim 11,
wherein the flow path plate includes a first flow path plate coupled to an upper portion of the external peripheral surface of the insulator, and a second flow path plate coupled to a lower portion of the external peripheral surface of the insulator, and
wherein the first flow path plate and the second flow path plate are located between the insulator and the external pipe in a state of being combined in a circular shape.

15. The vehicle mount of claim 14,
wherein each of the first flow path plate and the second flow path plate includes a main flow path formed on an external peripheral surface thereof in contact with an internal peripheral surface of the external pipe, wherein the main flow path is formed to extend in a circumferential direction of the external peripheral surface, and
wherein the main flow path includes flow path holes formed to pass therethrough, wherein each of the flow path holes is disposed at a position corresponding to each of the chambers of the insulator and configured to allow the fluid to be movable between a corresponding chamber among the plurality of chambers and the main flow path.

16. The vehicle mount of claim 15,
wherein the first flow path plate and the second flow path plate include connection flow paths respectively formed on external peripheral surfaces of opposite end portions of the first flow path plate and external peripheral surfaces of opposite end portions of the second flow path plate, wherein each of the connection flow paths allows the fluid to be movable from the main flow path of each of the first and second flow path plates to an end surface of each of the first and second flow path plates,
wherein the connection flow paths of the first and second flow path plates are connected to each other to allow the fluid to be movable therebetween in a state in which the first flow path plate and the second flow path plate are combined in the circular shape on the external peripheral surface of the insulator, and
wherein each of the connection flow paths respectively formed in the first and second flow path plates is formed to include a smaller flow path width and a smaller flow path cross-sectional area than a flow path width and a flow path cross-sectional area of the main flow path.

17. The vehicle mount of claim 16,
wherein a connection hole is formed between end portions of the connection flow paths respectively formed in the first flow path plate and the second flow path plate, and
wherein the connection hole is provided by forming a groove disposed between opposite end surfaces of the first and second flow path plates and connected to the connection flow paths, wherein the groove includes a larger width than a width of each of the connection flow paths.

18. The vehicle mount of claim 16,
wherein the insulator includes a groove formed on the external peripheral surface of the insulator and configured to allow the first flow path plate and the second flow path plate to be inserted thereinto and coupled thereto, and
wherein the insulator includes a rubber film located between the end surface of the first flow path plate and the end surface of the second flow path plate and formed to protrude to enable the end surfaces of the first and second flow path plates to be in contact therewith.

19. The vehicle mount of claim 18,
wherein the rubber film includes an opening formed at a center portion thereof, and
wherein the opening fluidically-communicates between the connection flow paths of the first and second flow path plates to enable the fluid to be movable therebetween.

20. The vehicle mount of claim 13,
wherein the first flow path plate and the second flow path plate include a main flow path, a damping flow path, and a fluid flow path formed on external peripheral surfaces thereof in contact with an internal peripheral surface of the external pipe, wherein each of the main flow path and the damping flow path is formed to extend in a longitudinal direction of each of the first flow path plate and the second flow path plate, and the fluid flow path connects the main flow path to the damping flow path,
wherein the main flow path includes flow path holes formed to pass therethrough, wherein each of the flow path holes is disposed at a position corresponding to each of the chambers of the insulator and enables the fluid to be movable between the chambers and the main flow path, and
wherein the damping flow path of the first flow path plate and the damping flow path of the second flow path plate are connected in a circular shape to form an annular flow path in a state that the first flow path plate and the second flow path plate are combined on the external peripheral surface of the insulator in the circular shape.
